(19) United States
(12) Patent Application Publication
(10) Pub. No.: US 2011/0268487 A1
(43) Pub. Date: Nov. 3, 2011

(54) KEYBOARD ASSEMBLY AND UNDERLYING DISPLAY DEVICE

(75) Inventor: Glen C. Larsen, Issaquah, WA (US)

(73) Assignee: MICROSOFT CORPORATION, Redmond, WA (US)

(21) Appl. No.: 12/771,701

(22) Filed: Apr. 30, 2010

(51) Int. Cl. B41J 5/00; B23P 17/04

(52) U.S. Cl. 400/490; 29/428

(57) ABSTRACT

The disclosure provides for a computer peripheral in which a display device produces images which may be viewed through a keyboard assembly that is disposed over the display device. Each the key of the keyboard assembly includes a keycap and a mechanical understructure that is configured to guide reciprocating movement of the keycap toward and away from the display device. The mechanical understructure is disposed away from a central portion of the keycap, to permit images produced by the display device to be viewed through the central portion of the keycap.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular liquid crystal display (LCD) can be situated above the function keys or number pad.

Another approach to combining input and output capability in a peripheral device is the use of a virtual keyboard on a touch interactive display. In this case, the display capability is provided directly on the keys: each key typically is displayed by the touch interactive device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile feedback, which can provide a more responsive and agreeable typing experience.

### SUMMARY

Accordingly, the disclosure provides for a computer peripheral in which a keyboard assembly with a plurality of keys is disposed over a display device so that images produced by the display device are viewable through the keyboard assembly. Each of the keys includes a keycap and a mechanical understructure that is configured to guide reciprocating movement of the keycap toward and away from the display device. The mechanical understructure is disposed away from a central portion of the keycap, to permit images produced by the display device to be viewed through the central portion of the keycap.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an exemplary computing system including a computer peripheral that provides the ability to display output in connection with the keys of a keyboard assembly.

FIG. 2 is an exploded view of the computer peripheral shown in FIG. 1, and shows viewable display output being provided by a display device underlying the keyboard assembly of the computer peripheral.

FIG. 3 illustrates an example of the output display capability that may be employed in connection with the computer peripheral of FIGS. 1 and 2.

FIGS. 4 and 5 are partially-sectioned views of an embodiment of a key that may be employed in connection with the computer peripheral of FIGS. 1 and 2.

FIGS. 6 and 7 are bottom and top perspective views of an embodiment of a keycap having a central transparent portion to facilitate through-key viewing of images produced by a display device underlying the keyboard assembly.

FIG. 8 illustrates an exemplary configuration for a keyboard assembly base structure having centrally offset tactile structures for providing tactile use feedback during key activation.

FIG. 9 is a side view of a key which illustrates viewing considerations associated with through-key viewing of images.

FIG. 10 is a top plan view of an exemplary key, showing a configuration in which the mechanical understructure of the key is positioned away from a central portion of the key cap, so as to reduce or eliminate interference with through-key viewing of images produced by an underlying display device.

### DETAILED DESCRIPTION

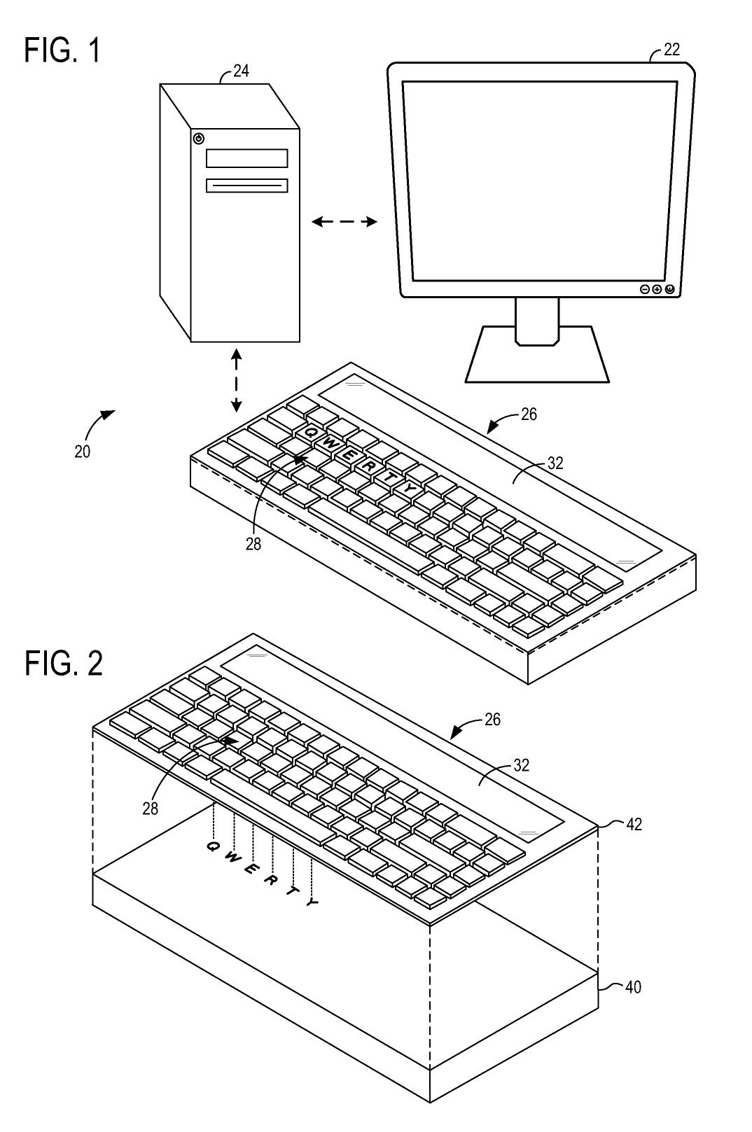

FIG. 1 depicts an exemplary computing system 20 including a display monitor 22, a component enclosure 24 (e.g., containing a processor, memory, hard drive, etc.), and a computer peripheral 26. FIG. 2 provides an additional view of computer peripheral 26 and exemplary components that may be used in its construction. As will be described in various examples, computer peripheral 26 may be implemented to provide displayable output in addition to keyboard-type input functionality.

In some examples, displayable output of the computer peripheral is provided from a liquid crystal display (LCD) or other display device, and is viewed through the keys of a keyboard assembly that is disposed over the top of the display device. Individual keys may be implemented via a keycap and a mechanical understructure that guides reciprocating up-and-down movement of the keycap, relative to the underlying display device. To facilitate through-key viewing of images, the mechanical understructure for a key may be disposed away from a central portion of the keycap.

The terms “input” and “output” will be used frequently in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc., on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of a piece of software running on computing system 20. For example, upon pressing of an “ALT” key, the key that otherwise is used to enter the letter “F” might instead result in activation of a “File” menu in a software application. Generally, it should be understood that the keys in the present examples may be selectively depressed to produce any type of input signal for controlling a computer.

Computer peripheral 26 can provide a wide variety of displayable output. In some examples, the computer peripheral causes a display of viewable output on or near the individual keys 28 to indicate key function. This can be seen in FIGS. 1 and 2, where instead of keys with letters painted, printed or etched onto the keycap surface, a display mechanism (e.g., a liquid crystal display (LCD) device situated under the keys) is used to indicate the “Q”, “W”, etc., functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based technology or other suitable methods.

Turning now to FIG. 2, computer peripheral 26 may include a display device 40 and a keyboard assembly 42 disposed over and coupled with the display device. Keyboard assembly 42 may be at least partially transparent, and may be otherwise configured to allow a user to view images produced by the display device through the keyboard assembly. In one embodiment, for example, each keycap has a central transparent portion, and a mechanical understructure is provided to guide and/or constrain reciprocating movement of the keycap toward and away from the display device. The mechanical understructure may be disposed away from a central portion of the keycap, to facilitate through-key viewing of images produced by the display device.

A variety of types of display device 40 may be employed. As indicated briefly above, one type of suitable display device is an LCD device. Indeed, LCD devices will be frequently referred to in the examples discussed herein, though this is non-limiting and it should be appreciated that the keyboard assembly may be coupled with a variety of other display types.

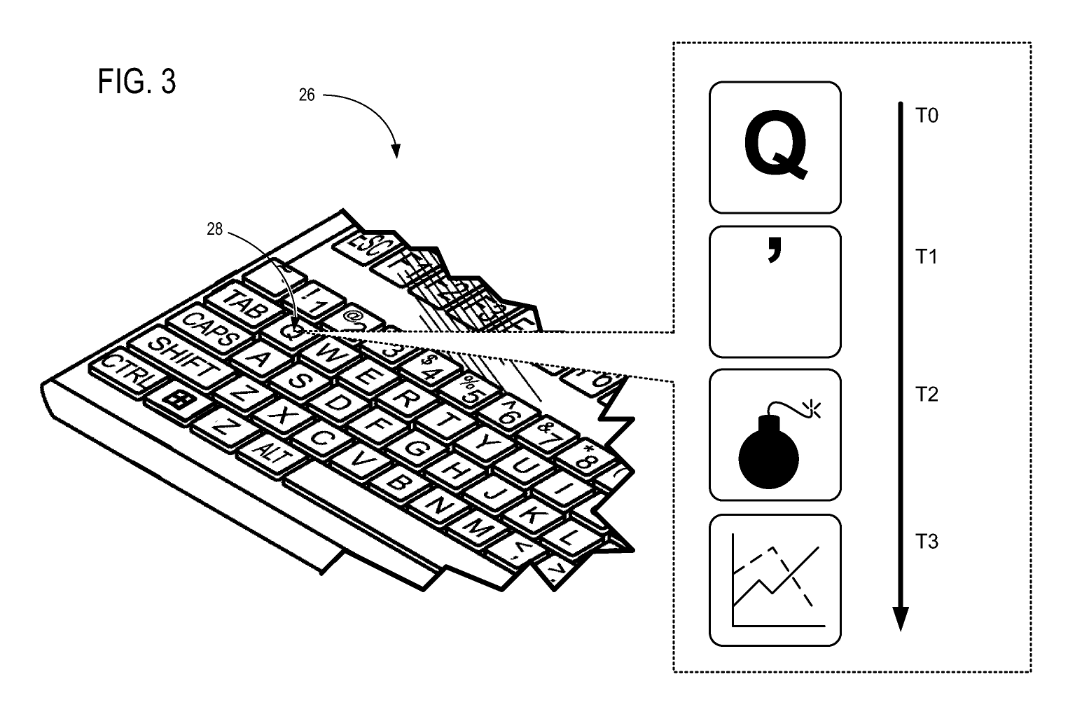

FIG. 3 provides further illustration of how the display capability of computer peripheral 26 may be employed in connection with an individual key 28. In particular, as shown respectively at times T₀, T₁, T₂, etc., the display output associated with key 28 may be changed, for example to reflect the input command produced by depressing the key. However, as previously mentioned, the viewable output provided by the computer peripheral may take forms other than displays associated with individual keys and their input functionality.

As in the examples of FIGS. 1 and 2, keyboard assembly 42 typically will include a plurality of keys employing some type of movement mechanism that enables the keys to be depressed or otherwise moved to produce an input signal. Although the term “keys” will be used primarily, this term is non-limiting, and should be understood to include buttons and any other structure or mechanism that may be moved by a user to provide input.

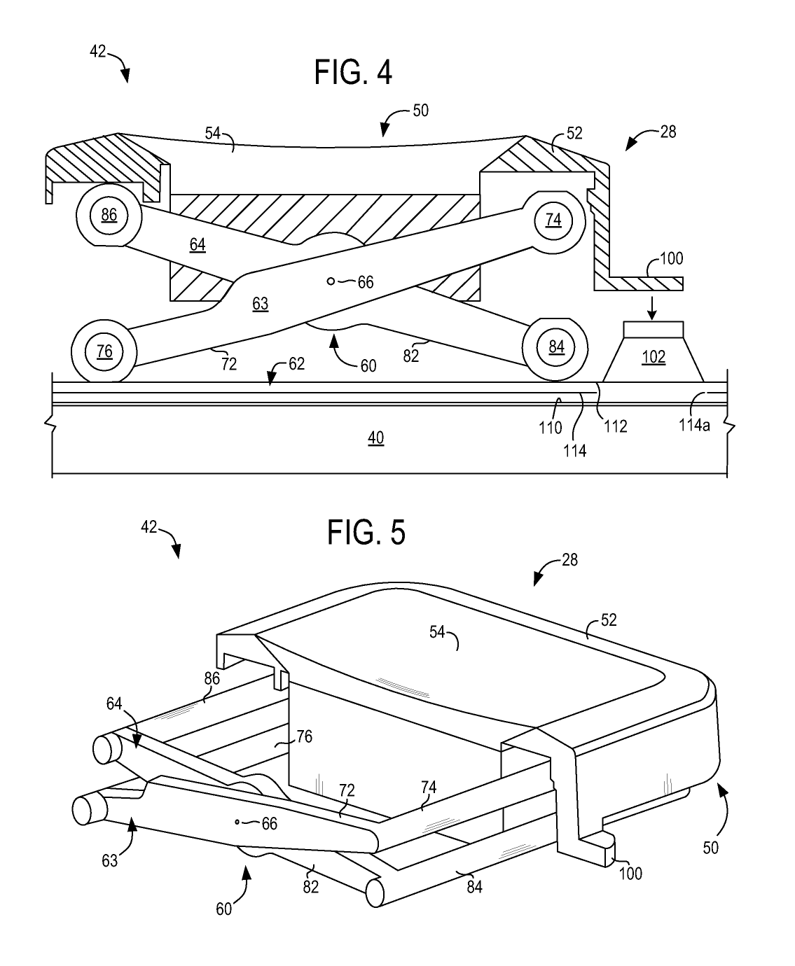

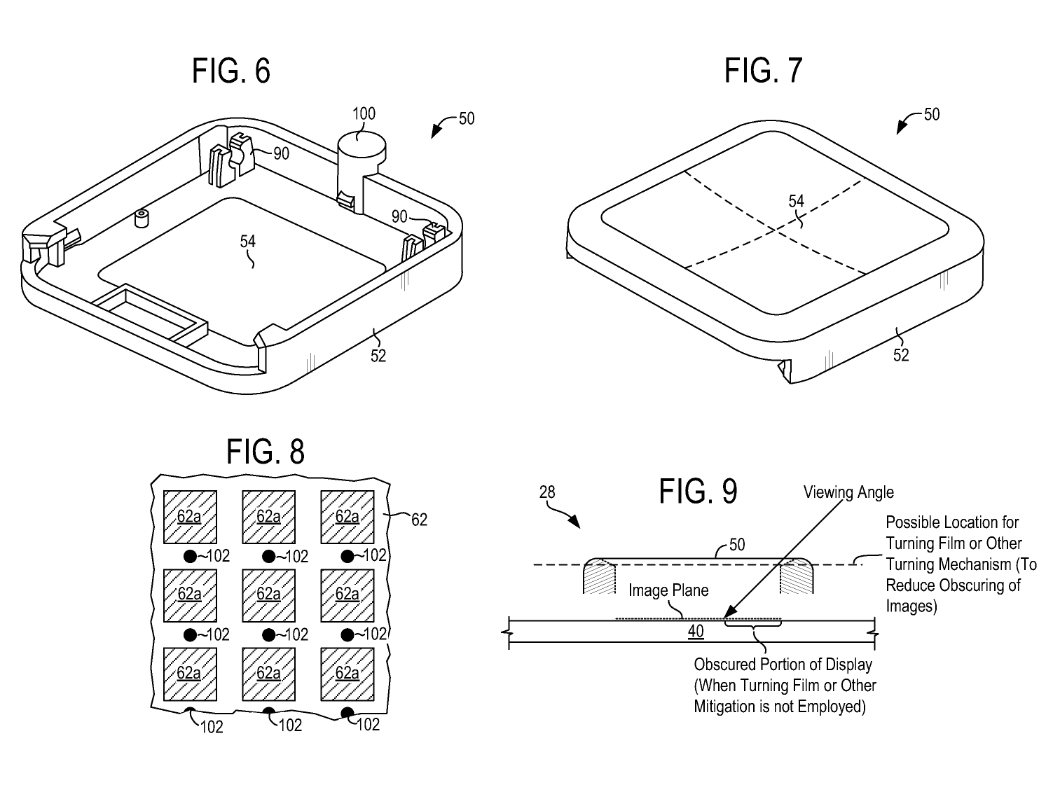

Referring now specifically to FIGS. 4 and 5, the figures show partially-sectioned views of a portion of keyboard assembly 42, including an embodiment of an individual key 28. Key 28 includes a keycap 50 having a perimeter portion 52 and a central portion 54. In some constructions, perimeter portion 52 and central portion 54 are formed as separate distinct pieces, and will thus sometimes be referred to as perimeter piece 52 and central piece 54. These structures can also be seen in FIGS. 6 and 7, which respectively provide bottom and top perspective views of keycap 50.

As indicated above, a mechanical understructure may be provided for each key to guide and/or constrain reciprocal upward and downward movement of keycap 50. In the examples of FIGS. 4 and 5, the understructure is implemented as a pivoting scissors assembly 60. It will be appreciated, however, that a variety of other understructures may be employed, including post-and-plunger arrangements; elastically-collapsible dome structures; mechanically-switched keys; cantilevered mechanisms; buckling springs and other types of springs; membrane-type movements; etc. Regardless of the particular movement mechanism employed for the key, the understructures contemplated herein will typically be disposed away from the central portion of the supported key. For example, the mechanical structure may be disposed to one side of the key, so as to not obstruct viewing of images through the key. Another approach is to have a perimetric configuration, in which the material of the understructure is at the periphery of the key, with an opening or aperture of the understructure being aligned with the central area through which images are viewed.

Continuing with the specific examples of FIGS. 4 and 5, the keyboard assembly may include a base structure 62 (FIG. 4) that is disposed over display device 40 (FIG. 4). When a base structure is included, each of the keycaps may be movably coupled to the base structure by a scissors assembly 60. Accordingly, each keycap is movable inward and outward relative to base structure 62 and display device 40.

The mechanical understructure (e.g., scissors assembly 60) may be variously configured to guide and/or constrain keycap movement. For example, it will often be desirable to ensure that the keycaps are constrained to move linearly inward and outward relative to the display device, without twisting or tilting. In addition, as indicated above, the understructure in many cases will be configured so that it is offset or otherwise positioned away from the center of the keycap. Such an arrangement can facilitate viewing of images produced by the underlying display device through the keycap.

In the depicted example, scissors assembly 60 is a pivoting assembly formed from a pair of rigid perimetric frames 63 and 64 that are pivotably coupled together via pivoting connection 66. The frames collectively form a collapsible pivoting mechanism that supports keycap 50 as it moves up and down during actuation. Each of the rigid perimetric frames generally conforms in shape to the outer edge or periphery of the supported keycap. When situated underneath the keycap, the frame bodies generally underlie a periphery of the keycap, and collectively define an opening or aperture through the scissors assembly. This opening typically is aligned with central portion 54 of keycap 50, so that the scissors assembly does not obstruct through-key viewing of images produced by display device 40.

Continuing with FIGS. 4 and 5, the construction of the rigid perimetric frames 63 and 64 will be described in more detail. In one exemplary approach, each perimetric frame includes a pair of opposed webs with a pair of rods extending between the webs. Specifically, perimetric frame 63 includes web 72. Rod 74 extends from a first end of web 72; rod 76 extends from a second end of web 72. The rods extend to an opposing similar web structure that is not shown in FIG. 4 and that cannot be seen in FIG. 5 due to concealment by keycap 50. The other rigid perimetric frame 64 includes similar structures: web 82, rods 84 and 86, and an opposing web structure (not shown).

Scissors assembly 60 may be variously configured and formed from a variety of different materials. In some embodiments, the entire structure may be plastic. It may be desirable in other examples to form some or all of the parts from metal. In particular, some embodiments employ plastic webs that are over-molded around metal connecting rods. Such use of over-molding and/or metal rods may be advantageous when stiffness and rigidity are of particular concern, for example in the case of large format keys (e.g., the “shift” key or “spacebar” key of a keyboard). Further still, the entire scissors assembly may be formed from metal or another suitably rigid material other than plastic.

It will be appreciated that the portions of the scissors assembly 60 pivot relative to one another when the key is depressed downward toward base structure 62. The pivoting action results in an overall lowering of the scissors assembly, and produces a slight increase in the effective length of the scissors assembly. To accommodate this length variation, the scissors assembly may be coupled with adjoining structures in a way that allows for some lateral movement. Referring specifically to the example of FIG. 4, the portions of scissors assembly 60 are engaged with keycap 50 and base structure 62 as follows:
Rod 74 is snapped into a pair of snap hooks 90 (shown in FIG. 6 but not in FIGS. 4 and 5) provided on the underside of keycap 50. This engagement allows rotation of the rod, as will occur during depression of the key, but maintains the lateral position of the rod relative to the keycap.
Rod 86 abuts the underside of keycap 50, but is allowed to slide somewhat laterally during depression of the key, to accommodate the effective lengthening of the scissors assembly that occurs during collapse.
Rod 84 is held by a pair of snap hooks (not shown) on base structure 62, while rod 76 abuts the base structure but is permitted to slide laterally relative to the base structure. Similar to rods 74 and 86, this arrangement holds the scissors assembly generally in place while allowing for the effective length variation that occurs during the pivoting operation of the scissors assembly.

With reference to FIG. 5, it will again be appreciated that the scissors assembly may be disposed to the periphery of each key, thereby leaving the central area of the key/keycap unobstructed and maximally available for display purposes. In particular, when keycap 50 is viewed straight on from the top of the key, the webs and rods of the scissors assembly are all positioned at the periphery of the key, underneath perimeter piece 52 of the keycap. Thus, when an LCD or other display device is employed under the keyboard assembly, the peripherally-configured scissors assemblies allow for a greater portion of the display to be viewed without obstruction through the key (i.e., through transparent central piece 54).

Continuing with FIGS. 4 through 7, other structures and mechanisms may be employed in connection with the actuation of the key. In the present example, as keycap 50 is depressed toward base structure 62 (FIG. 4), a plunger or tab-like protrusion 100 will depress a tactile structure, such as tactile feedback dome 102 (FIG. 4), which is associated with the key. As the key moves from the rest position toward its fully depressed state, the tactile feedback dome will eventually collapse and cause a palpable change in the action or feel of the key.

In addition to collapsing the feedback dome, the depression of the key causes occurrence of an electrical event which produces the input signal or command associated with the key. This may be achieved through use of a switch or other state detector that is responsive to depression of the keycap. In one example, a three-layer construction is used on base structure 62, in which conductors 110 and 112 are separated by insulating layer 114. The layers collectively form a switch mechanism. In particular, depression of the key and collapse of the tactile feedback dome causes conductors 110 and 112 to contact each other through a hole 114a in insulating layer 114, thus establishing an electrical connection which produces the input signal. This is but one example of a switching mechanism; a variety of other state detectors may be employed, including detectors that detect more than whether the key is in an “up” or “down” state. For example, pressure detection or other methods may be used to determine multiple states, including intermediate key-press positions and/or the force applied to a key.

Regardless of the exact mechanism by which the signal is generated, use of a tactile structure can provide tangible, haptic feedback which affirms that the user's physical movement (i.e., pressing of the key) has sent the desired input signal to the attached computer. The tactile structures typically are elastically deformable and may be implemented as tactile feedback domes formed from metal or silicone, or other elastomeric or rubber-like dome structures, to name but a few possible examples. Selection of a particular type of tactile structure may be informed by tradeoffs and considerations relating to key feel, keyboard thickness, display performance, manufacturing concerns, robustness, reliability and the like. As will be described in more detail below, display performance can be enhanced in certain embodiments by having a thinner keyboard assembly. Tactile feedback domes made of metal can often be employed to reduce the keyboard assembly thickness (relative to other types of domes), however in some cases these domes are less desirable from a tactile feel standpoint. Conversely, a rubber-like tactile dome may provide the desired feel or action for the keyboard, but at the expense of an increased thickness which can affect the display performance.

FIG. 8 shows an exemplary arrangement of tactile structures on or in relation to base structure 62. Specifically, the figure shows a portion of base structure 62 corresponding to a region containing nine square-format keys, for example, from a central portion of the keyboards shown in FIGS. 1-3. For clarity of illustration, the keys themselves are not shown in the figure. The hashed regions indicate holes 62a in the base structure 62. These holes are generally aligned with the transparent central portions of the keycaps (e.g., central transparent pieces 54—shown in FIGS. 4-7), to facilitate viewing through the keyboard assembly to the underlying display device. The figure also shows that the tactile structure for each key (e.g., tactile domes 102) is offset from the central display portion of the key, so as to not interfere with the display functionality. Indeed, similar to the scissors assembly configuration discussed in connection with FIGS. 4 and 5, the tactile structures are positioned at the periphery of the keys so as to maximize use of the central portion of the key for display. In addition to or instead of holes 62a, base structure 62 may be constructed from a transparent material to facilitate the display capability. Also, the base structure may include a rigid piece or expanse to retain and/or support the key structures, and a separate flexible portion containing the insulating and conducting layers that provide the above-described electrical switching and connectivity.

As an alternative to the depicted arrangement, the tactile structures may be provided in other locations that do not impede display of images through the keycaps. For example, the tactile structure may be provided at a top or side edge of the holes in the base structure, as opposed to a bottom edge. Furthermore, tactile structures may be positioned underneath the scissors assembly such that they are compressed by actuation of the scissors assembly. Regardless of the particular configuration, the centrally-offset position of the tactile structures will often be desirable in that it minimizes or eliminates the possibility of interfering with the through-key display functionality.

As discussed throughout, various considerations can arise relating to the viewing of images produced by display device 40 (FIG. 2). Some of these considerations relate to the fact that in the typical arrangement, the image source (i.e., display device 40) is located under keyboard assembly 42. The user must therefore be able to look “through” the keyboard assembly to see the images. On the other hand, some portions of the keyboard assembly may not be transparent for various reasons, and it may be desirable to configure such “non-display” portions of the keyboard so that they do not detract from or otherwise impede the display functionality.

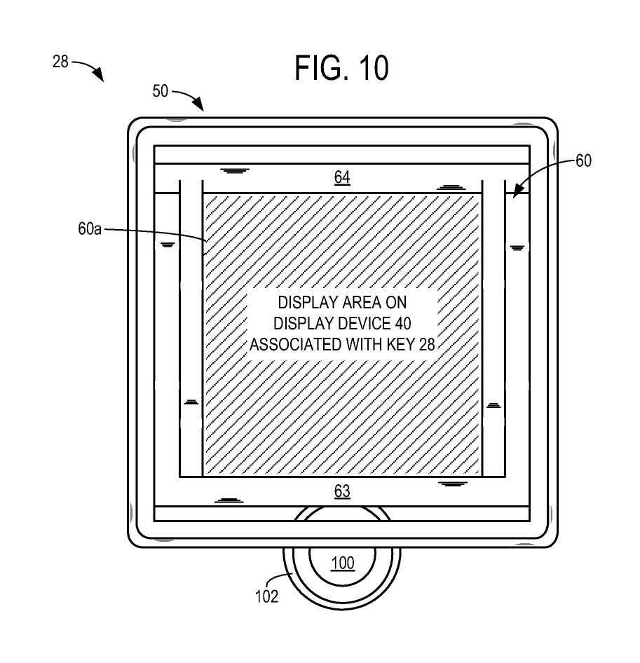

In some cases, it may be desirable to implement a display device in which the image plane is beneath the keys, at the surface of the display device. This is in contrast to a method involving projection of the image plane to a location on top of the keys, at some distance above the surface of the display device. Referring to FIG. 9, the figure shows a simplified schematic of key 28 disposed over display device 40. The keycaps and related structures have a height (e.g., between 2 and 10 millimeters), and therefore there is a potential for a “tunnel” effect through the center of each key, in which the user is looking through a rectangular tube to see the image associated with the key. Given an approximate viewing angle of 45 degrees, the height of the key results in a significant portion of the image plane being obscured, as indicated in the figure.

The obscuring of the display may be mitigated to some extent through use of a turning film, prism, and/or other turning element employed in the central portion of the key. In particular, it will be desirable in some embodiments to employ a turning element in connection with the keycap. It will often be desirable that the turning element be employed near the top of the key, for example near the upper surface of the keycap 50. Light rays from the underlying display device would then be refracted toward the user at a point near the top of the key. Because the refraction is occurring near the top of the key, the sidewall portions of the key will obscure less of the display. FIG. 9 indicates a potential location for employing a turning film or prism. When employed, a turning film section or layer may be co-molded with the keycap, or may be joined to the keycap via adhesive, snap-fitting, ultrasonic-welding or any other suitable joining method. In addition to or instead of a turning film, the turning element may be implemented with a turning prism. As with the turning film, the turning prism may be implemented so that the point of refraction is near the top of the key.

As indicated above, the keys of the computer peripheral will typically be employed so that the central portion of each keycap is transparent, allowing the user to see images from the display device through the keycap. As previously discussed, it will often be desirable to configure supporting mechanical components (e.g., the scissors assembly) so that they are located at the periphery of the key, so as to not block images being viewed through the central portion of the key. Furthermore, for aesthetic and other reasons, in some cases the peripheral portion of the keycap will be made opaque in order to conceal the scissors assembly (e.g., to provide a cleaner look and/or to prevent visual distractions that might distract from the images being provided by the display device).

One approach to providing opacity at the periphery while permitting light/images to pass through the center is to form the keycap as a single transparent piece and then paint the periphery of the keycap. Precision painting operations can be difficult, however, and particularly so when performed in mass production settings with small parts. Also, the painting operation is a separate step that can increase the time and cost of manufacturing. Accordingly, in some cases it will be advantageous to form a two piece keycap in which the central portion and the perimeter portion are separate. The above-described examples discussed with respect to FIGS. 4 through 7 all provide examples of such a two-piece keycap construction.

Separate-piece constructions for keycap 50 may be achieved in a variety of ways. In some embodiments, central piece 54 and perimeter piece 52 are molded or otherwise formed separately, and then affixed to one another in a separate joining step. Attachment may be achieved via snap fitting, adhesive (e.g., pressure-sensitive adhesive), ultrasonic welding, or any other suitable joining method. Alternatively, the two pieces may be formed as separate distinct pieces, but in a co-molding process, in which one of the pieces is molded first, and then the second piece is molded onto or over the first.

FIG. 10 provides a top view of key 28, which further illustrates the example periphery configuration that may be employed for the mechanical understructure that guides and/or constrains the movement of keycap 50. The depicted example employs the rigid perimetric frame construction of FIGS. 4 and 5: rigid perimetric scissor frame 64 is coupled to rigid perimetric scissor frame 63 to form a pivoting scissors assembly 60 that underlies the periphery of keycap 50. The frame members define an aperture 60a which is aligned centrally with the key to maximize through-key viewing of images from the underlying display device. The figure also shows protrusion 100 and tactile structure 102. The scissor frame members in the example may be moved relatively inward or outward from their depicted positions with respect to the central display area, though it typically will be desirable to maximize the viewable central display area while balancing other design considerations. It should again be understood that a pivoting scissors assembly with a central aperture is but one example of a mechanical understructure disposed away from the central viewing area. Various other understructures may be employed, such as post-and-plunger arrangements, buckling springs, etc., in which the understructure is offset to reduce or eliminate obstruction of through-key viewing of images.

Computing systems such as that depicted in FIG. 1 may include various components to implement functionality in connection with the computer peripheral examples discussed herein. The input and output functionality of the example computer peripherals may be carried out, for example, using instructions that are executed by a processor or other logic subsystem. The processor may execute these instructions as part of one or more programs, routines, objects, components, data structures, or other logical constructs. Such instructions may be implemented to perform a task, implement a data type, transform the state of one or more devices, or otherwise arrive at a desired result.

Executable instructions may be employed, for example, by a processor in component enclosure 24 to generate a displayable output on display device 40 for each of the keys of keyboard assembly 42 (FIGS. 1 and 2). The displayable output for each key may be dynamic and change in response to inputs or changes in the state or context of a software application running on computing system 20. For example, the displayable output for one or more of the keys may vary in response to an input signal provided from computer peripheral 26. For example, pressing the “ALT” key could result in an input signal which in turn causes the displayed output for one or more keys to change, so that indicia are displayed corresponding to alternate functions associated with the keys.

The executable instructions may be held, along with other data, in any appropriate data-holding subsystem. When instructions are executed to carry out the methods and processes described herein, the result may include the transformation of data held in the data-holding subsystem. Data may be held on removable and/or built-in devices/media, including optical memory devices, semiconductor memory devices, and/or magnetic memory devices, among others. Suitable data-holding devices/media may have one or more of the following characteristics: volatile, nonvolatile, dynamic, static, read/write, read-only, random access, sequential access, location addressable, file addressable, and content addressable.

Display device 40 may form part of a computing system's display subsystem. As the herein described methods and processes change the data held by the data-holding subsystem, and thus transform the state of the data-holding subsystem, the state of display subsystem may likewise be transformed to visually represent changes in the underlying data. For example, the visual output from display device 40 that is viewable through keyboard assembly 42 may change.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer peripheral, comprising:
a display device; and
a keyboard assembly disposed over the display device and configured to permit viewing of images produced by the display device through the keyboard assembly, the keyboard assembly including a plurality of keys, wherein each of the plurality of keys includes a keycap and a mechanical understructure configured to guide reciprocating movement of the keycap toward and away from the display device, the mechanical understructure being disposed away from a central portion of the keycap, to permit viewing of images produced by the display device through the central portion of the keycap.

2. The computer peripheral of claim 1, wherein the keyboard assembly further includes a base structure disposed over the display device, with the keycap for each of the plurality of keys being movable toward and away from the base structure.

3. The computer peripheral of claim 2, wherein for each of the plurality of keys, the mechanical understructure is a pivoting scissors assembly that movably couples the keycap to the base structure.

4. The computer peripheral of claim 3, wherein the pivoting scissors assembly is disposed at a periphery of the keycap and wherein an aperture of the pivoting scissors assembly is aligned with the central portion of the keycap to permit images produced by the display device to be viewed through the keycap and the pivoting scissors assembly.

5. The computer peripheral of claim 3, wherein the pivoting scissors assembly includes a first rigid perimetric frame pivotably coupled to a second rigid perimetric frame, the first rigid perimetric frame and the second rigid perimetric frame underlying a periphery of the keycap and defining an aperture that is aligned with the central portion of the keycap to permit images produced by the display device to be viewed through the keycap and the pivoting scissors assembly.

6. The computer peripheral of claim 1, wherein the keyboard assembly further includes a base structure disposed over the display device, with the keycap for each of the plurality of keys being movable toward and away from the base structure, wherein a tactile structure is provided on the base structure for each of the plurality of keys to provide tactile user feedback when the keycap is depressed toward the base structure and display device.

7. The computer peripheral of claim 6, wherein for each of the plurality of keys, the tactile structure is centrally offset from the keycap.

8. The computer peripheral of claim 6, wherein for each of the plurality of keys, the tactile structure is an elastically-deformable tactile feedback dome.

9. The computer peripheral of claim 6, wherein for each of the plurality of keys, the base structure includes a state detector responsive to depression of the keycap toward the base structure.

10. The computer peripheral of claim 1, wherein the display device is a liquid crystal display.

11. A method of manufacturing a computer peripheral, comprising:
providing a display device;
assembling a keyboard assembly from a base structure and a plurality of keycaps, wherein for each of the plurality of keycaps, a mechanical understructure is operatively coupled between the keycap and the base structure to guide and constrain movement of the keycap toward and away from the base structure, and is disposed away from a central portion of the keycap to permit viewing of images produced by the display device through the central portion of the keycap; and
disposing the keyboard assembly over the display device.

12. The method of claim 11, wherein for each of the plurality of keycaps, the mechanical understructure is a pivoting scissors assembly that movably couples the keycap to the base structure.

13. The method of claim 12, wherein the pivoting scissors assembly is disposed at a periphery of the keycap and wherein an aperture of the pivoting scissors assembly is aligned with the central portion of the keycap to permit images produced by the display device to be viewed through the keycap and the pivoting scissors assembly.

14. The method of claim 12, wherein the pivoting scissors assembly includes a first rigid perimetric frame pivotably coupled to a second rigid perimetric frame, the first rigid perimetric frame and the second rigid perimetric frame underlying a periphery of the keycap and defining an aperture that is aligned with the central portion of the keycap to permit images produced by the display device to be viewed through the keycap and the pivoting scissors assembly.

15. The method of claim 11, further comprising providing executable instructions configured to cause the display device to generate, for each of the plurality of keycaps, a displayable output that is viewable through the keycap.

16. The method of claim 15, wherein the executable instructions are configured to cause the displayable output for at least one of the plurality of keycaps to vary in response to an input signal produced via user operation of one of the plurality of keycaps.

17. The method of claim 11, further comprising providing, for each of the plurality of keycaps, a state detector configured to produce an input signal in response to depression of the keycap toward the base structure.

18. The method of claim 11, further comprising providing, for each of the plurality of keycaps, a tactile structure at the base structure that is configured to provide tactile user feedback as the keycap is depressed toward the base structure.

19. The method of claim 18, wherein the tactile structure is elastically deformable and centrally offset from the central portion of the keycap.

20. A computer peripheral, comprising:
a display device; and
a keyboard assembly including:
a plurality of keycaps;
a base structure disposed over the display device; and
for each of the plurality of keycaps, a pivoting scissors assembly between the keycap and the base structure to guide reciprocating movement of the keycap toward and away from the base structure, the pivoting scissors assembly defining an aperture that is aligned with a central portion of the keycap to permit images produced by the display device to be viewed through the central portion of the keycap.
